(19) United States
(12) Patent Application Publication
(10) Pub. No.: US 2019/0239682 A1
(43) Pub. Date: Aug. 8, 2019

(54) THERMAL INSULATED CUP WITH DUAL-WELL DOCK

(71) Applicants: Frank D. Lee, Hillsborough, CA (US); Eric Dah Lee, Hillsborough, CA (US)

(72) Inventors: Frank D. Lee, Hillsborough, CA (US); Eric Dah Lee, Hillsborough, CA (US)

(21) Appl. No.: 16/045,538

(22) Filed: Jul. 25, 2018

(30) Foreign Application Priority Data
Feb. 6, 2018 (CN) 201820210508.8

(51) Int. Cl. A47J 36/24; A47G 19/22; H01M 10/48; H01M 2/20; H02J 7/00

(52) U.S. Cl. CPC A47J 36/2472; A47G 19/2227; A47G 19/2288; A47G 19/2272; H01M 10/488; H01M 2220/30; H02J 7/0044; H02J 7/0047; H02J 7/0013; A47G 2019/225; H01M 2/20

(57) ABSTRACT

A thermal insulated cup can include cup module and a battery module. The battery module is provided with a first magnetic absorption module. The cup module is provided with a second magnetic absorption module, and an electric heating component and a power interface, the power interface is connected with the electric heating component, and the first magnetic absorption module and second magnetic absorption module absorb jointly to enable an electrical connection between the battery module and the power interface. A magnetic absorption type contact between the battery module and the cup module by arranging a first magnetic absorption module on the battery module and a second magnetic absorption module on the cup module, so that the power supply is easy to detach or change, enabling a long-time thermal holding of the thermal insulated cup.

### CROSS REFERENCE TO RELATED APPLICATIONS

The present application is related to, and claims priority to, China Utility Model Application No. 201820210508.8, filed Feb. 6, 2018, which is incorporated by reference herein in its entirety.

### BACKGROUND

### 1. Field of the Invention

The present application is related to a thermal mugs and, in particular, to a battery-assisted thermal insulated mugs having a dock with dual charging wells.

### 2. Background Art

With the development of electronic and battery technology, thermal insulated cups are becoming more intelligent and developing in the areas of control and electric charging. Existing thermal insulated cups carry a battery that cannot be detached, as the battery is integrated with the cup. As the battery is non-detachable from the cup, a single battery has a limited capacity and cannot be used continuously after electricity is exhausted. Limited by the existing charging technology, the battery needs to be charged for several hours before it can be normally used again, making the use of rechargeable thermal insulated cups very inconvenient and greatly limiting the their use.

### SUMMARY

The present embodiments provide a thermal cup, having a cup module and a battery module. The battery module is provided with a first magnetic absorption element. The cup module is provided with a second magnetic absorption element. The cup module is provided with an electric heating component and a power interface, and is a two-layer insulated thermal cup. The power interface is electrically coupled to the electric heating component. The first and second magnetic absorption elements absorb jointly to enable an electrical connection between the battery module and the power interface. In certain embodiments, the first magnetic absorption element and the second magnetic absorption element are both magnets. In other embodiments, one of the first or second magnetic absorption element is magnet and the other thereof is a non-magnet absorption element that is able to match magnet absorption. In selected embodiments, the cup module further includes a base, in which the cup module base includes a second electric connector and the battery module includes a second connector. In the selected embodiments, the battery module includes a battery core, the second metal conductor is located in the second ring groove, the second metal conductor is connected with the battery core, and the base contains the second electrical connector that is electrically connected with the second metal conductor. Selected embodiments also can have a charging dock module configured to contain the cup module or the battery module. In other selected embodiments a charging dock module configured to contain the cup module and the battery module. In selected embodiments, a charging dock module configured to contain two battery modules. The thermal cup also can contain a cap module configured to sealingly fit a mouth of the cup module, and a lid in the cap module configured to open and close a lid and to selectively release contents of the cup module.

Further embodiments include a thermal cup having a cup module; a cap module; and a battery module. The cup module is a two-layer cup module having an inner tank is provided with an electric heating component for warming beverages in the cup module, and a power interface. The battery module includes a rechargeable battery therein and the rechargeable battery is electrically coupled to the power interface, providing power to the electric heating component. The cap module is configured to sealingly fit onto the cup module, securing the cup module contents therein. Each of the cup module and the battery have complementary magnetic elements, configured to attract each other when the cup module is magnetically proximate to the battery module. An electrical connection is made between the cup module and the battery module when the cup module and battery module are in magnetic contact. In some embodiments, the cup module further includes a cup indicator element configured to indicate a condition of the cup module contents. A condition of the cup module contents is a temperature of the cup module contents. The battery module further includes a battery indicator element configured to indicate a charge state of the battery module. The cup module further comprises an electric heating element.

### BRIEF DESCRIPTION OF THE DRAWINGS

Embodiments of the present invention disclosed herein are illustrated by way of example, and are not limited by the accompanying figures, in which like references indicate similar elements, and in which:

FIG. 1 is a perspective illustration of a thermal insulated cup module, in accordance with the teachings of the present invention;

FIG. 2 is a perspective illustration of the thermal insulated cup module of FIG. 1, inverted, in accordance with the teachings of the present invention;

FIG. 3 is a perspective illustration of a magnetic battery module, in accordance with the teachings of the present invention;

FIG. 4 is a perspective illustration of the magnetic battery module of FIG. 3, inverted, in accordance with the teachings of the present invention;

FIG. 5 is a perspective illustration of the front side of a docking module configured to receive therein the cup module of FIG. 1 and the battery module of FIG. 3, in accordance with the teachings of the present invention;

FIG. 6 is a perspective illustration of the rear side of the docking module of FIG. 5, shown with the cup module of FIG. 1 and the battery module of FIG. 3 nestled therein, in accordance with the teachings of the present invention;

FIG. 7 is a perspective view of a docking module having a coupled cup module and battery module received in a well of the docking module, in accordance with the teachings of the invention;

FIG. 8 is a top perspective view of a cap module configured to be sealingly received by the corresponding cup module, in accordance with the teachings of the present invention;

FIG. 9 is a top perspective view of the cap module of FIG. 8, configured to be fluidly opened in the corresponding cup module, in accordance with the teachings of the present invention;

FIG. 10 is a perspective view of a cup module, configured to receive a cap module, in accordance with the teachings of the present invention;

FIG. 11 is a cross-section of a battery module portion configured to receive the cup module with a heating device therein, in accordance with the teachings of the present invention;

FIG. 12 is an inverted perspective view of the cap module of FIG. 8, in accordance with the teachings of the present invention; and

FIGS. 13A-D is a schematic diagram of the power and control circuit, in accordance with the teachings of the present invention.

Skilled artisans can appreciate that elements in the figures are illustrated for simplicity and clarity and have not necessarily been drawn to scale. For example, the dimensions of some of the elements in the figures may be exaggerated relative to other elements to help improve the understanding of the embodiments of the present invention. In the figures, like numbers correspond to like elements.

### DETAILED DESCRIPTION OF THE EMBODIMENTS

The present embodiments of the Thermal Insulated Cup With Dual-Well Dock are illustrated with respect to the drawings and the accompanying description. The thermal insulated cup herein includes a cup module, and a battery module, detachably coupled to the cup module. Embodiments can include a cap module, which sealingly inserts into the cup module. The cap module can be a threaded cap module which mates with an opening of the cup module. A dual well charging dock may also be included, which is configured to receive the cup module, the battery module, or both, or two battery modules.

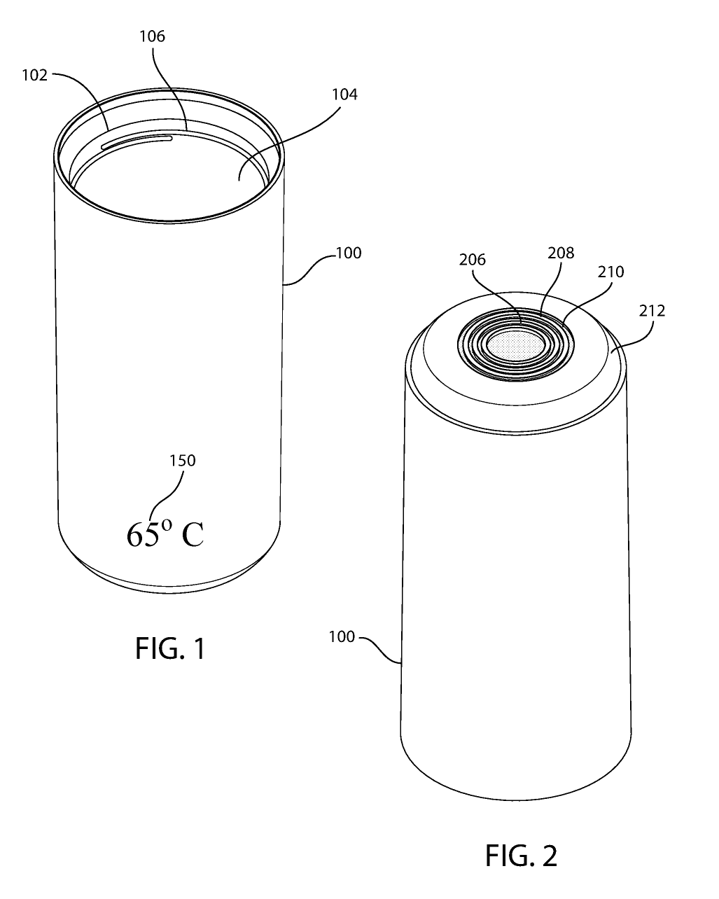

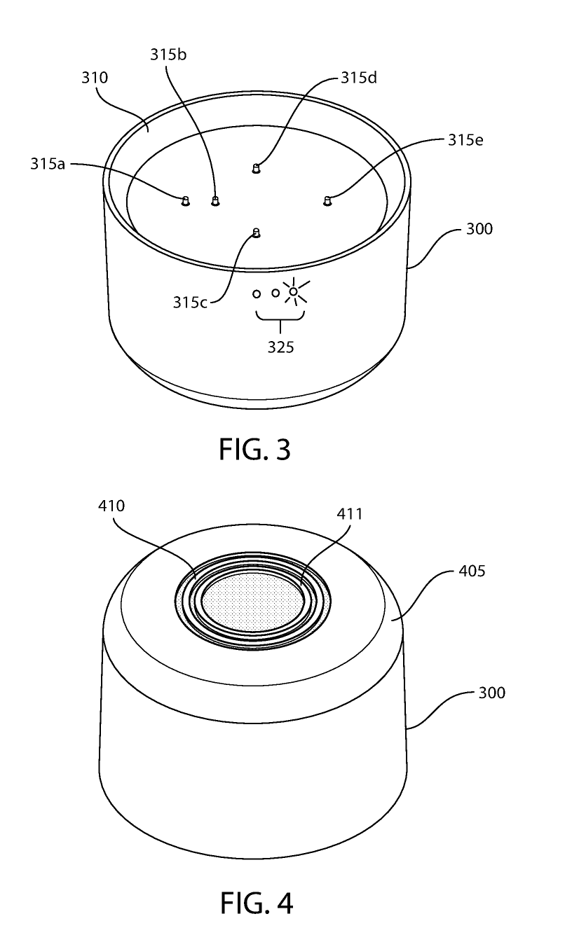

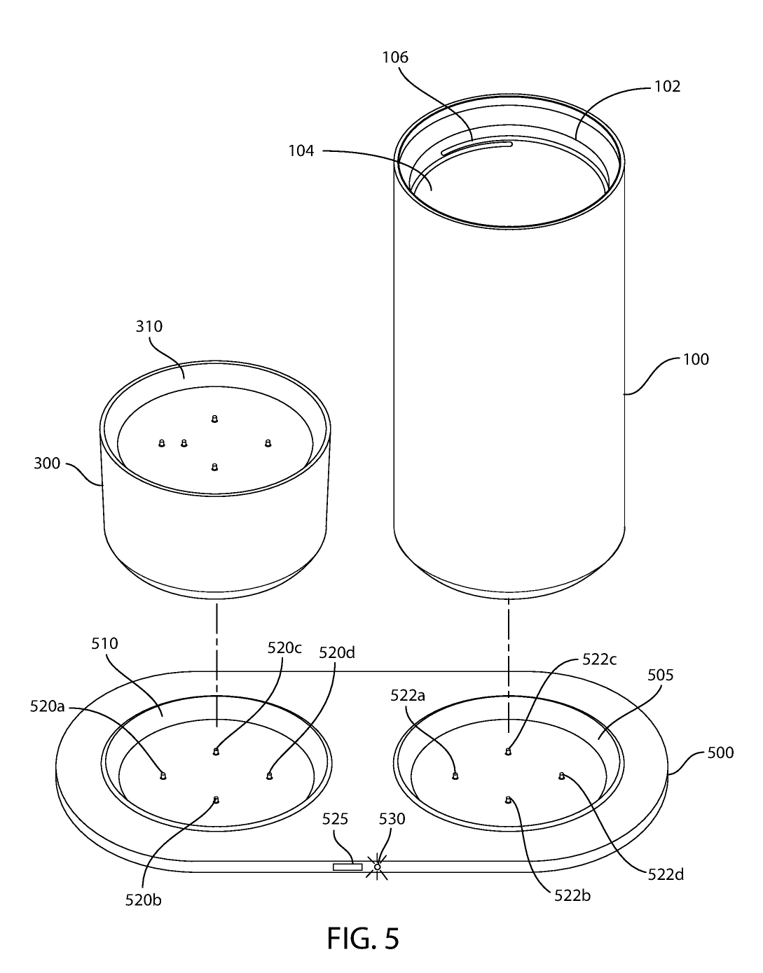

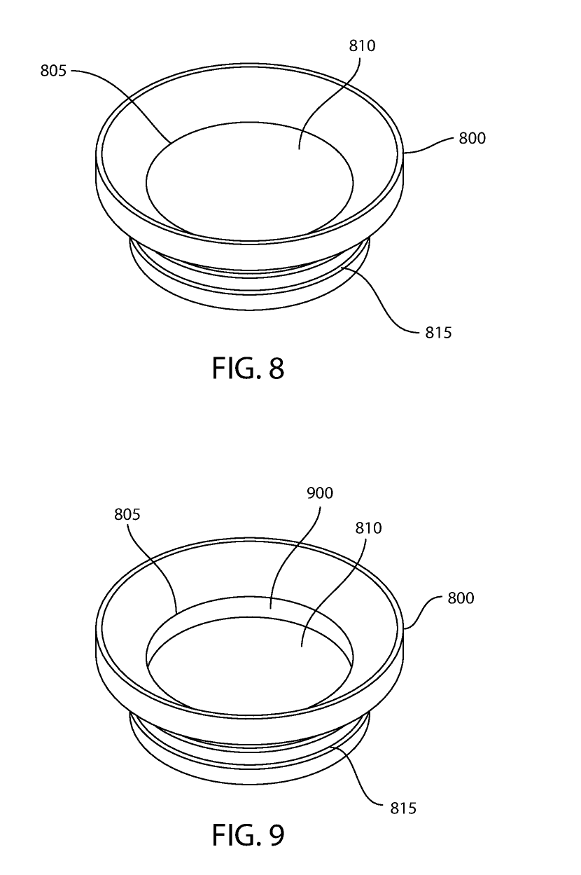

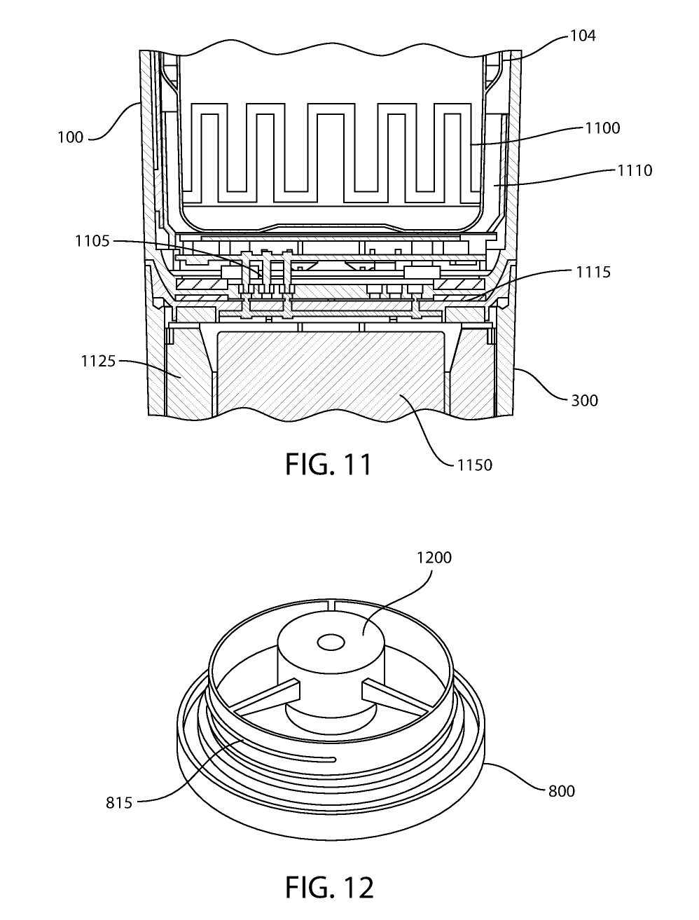

FIGS. 1 and 2 illustrate upright (FIG. 1) and inverted (FIG. 2) views of thermal insulated cup module 100. Thermal insulated cup module 100 can be generally cylindrical, although other form figures may be used. As seen in FIG. 1, thermal insulated cup module 100 can include cup lip 102, inner tank 104, and cup module thread 106. Cap module 800 (FIG. 8) can be configured to be received by cup lip 102, and can be sealingly fitted onto cup module 100 using cup module thread 106. Inner tank 104 can be a stainless steel liner, such as Type 304 stainless steel, securely fitted into cup module 100. The presence of inner tank 104 provides two-layer insulated cup module 100. Cup module 100 also may include indicator 150, which displays the temperature of cup module 100 contents. FIG. 2 shows an inverted thermal insulated cup module 100 which includes inner annular conduction ring 206 in a first ring groove, intermediate annular conduction ring 208 in a second ring groove, and outer annular conduction ring 210 in a third ring groove. In general, the first, second, and third ring grooves are configured to provide, with the respective conduction rings seated therein, a flat surface on the base 212 of cup module 100. Cup conduction rings 208, 210 convey power from battery module 300 (FIG. 3) to a heating device incorporated into cup module 100. Alternatively, cup conduction rings 208, 210 can convey power from charging dock module 500 (FIG. 5). Second magnetic element 1110 (FIG. 11) can be held securely in base 212 of cup module 100. Rounded base 212 has a flat bottom and is configured to receive and to electrically mate with battery module 300.

FIGS. 3 and 4 illustrate upright (FIG. 3) and inverted (FIG. 4) battery module 300. Battery module 300 contains therein a rechargeable battery (battery 1150 in FIG. 11), for example, a Li-ion battery, and a first magnetic element (magnetic element 1125 in FIG. 11). FIG. 3 illustrates contact pins 315a-315e, which convey battery power to concentric annular conduction rings 208, 210. Pin 315b can be configured to contact inner annular conduction ring 206. Pins 315a, 315e can be configured to contact outer annular conduction ring 210. Pins 315c, 315d can be configured to contact intermediate annular conduction ring 208. Pins 315a, 315c, 315d, 315e convey battery power from battery module 300 to cup module 100 (see FIG. 11). Pins 315a, 315e can be the positive pole pins, and pins 315c, 315d can be the negative pole pins. Pin 315b may be a power detection pin, and can convey information between battery module 300 and cup module 100, for example, whether battery module 300 is electrically coupled to cup module 100. Beveled side 310 on battery module 300 is configured to receive rounded base 212 of cup module 100. Battery module 300 also may include battery charge state indicators 325, which display the charge state of the battery in battery module 300. The first electrical connector includes first positive pole pins and first negative pole pins. The first electrical connector of the base 212 forms an electrical connection in combination with the intermediate annular conduction ring 210. Both the first positive pole pins and the first negative pole pins are plural. In embodiments, the number of both the first positive pole pins and first negative pole pins is two, thus ensuring the reliability of electrical connection contact. The second electrical connector includes second positive pole pins and second negative pole pins. Both the second positive pole pins and the second negative pole pins are plural. The second electrical connector of the base 212 forms an electrical connection in combination with the intermediate annular conduction ring 208. In the specific embodiment, the number of the second positive pole pins and second negative pole pins is two, thus ensuring the reliability of electrical connection contact. The pin-and-ring combination of the electrical connections allow quick, accurate placement of the proper pins on the respective annular conduction rings.

FIG. 4 illustrates an inverted battery module 300 having outer annular conduction ring 410 and inner annular conduction ring 411. Conduction rings 410, 411 can convey power from charging dock module 500 (FIG. 5) to cup module 100 through battery module 300. In FIG. 4 a rounded battery module base 405 can be configured to be received by one of wells 505, 510 of charging dock module 500 (FIG. 5).

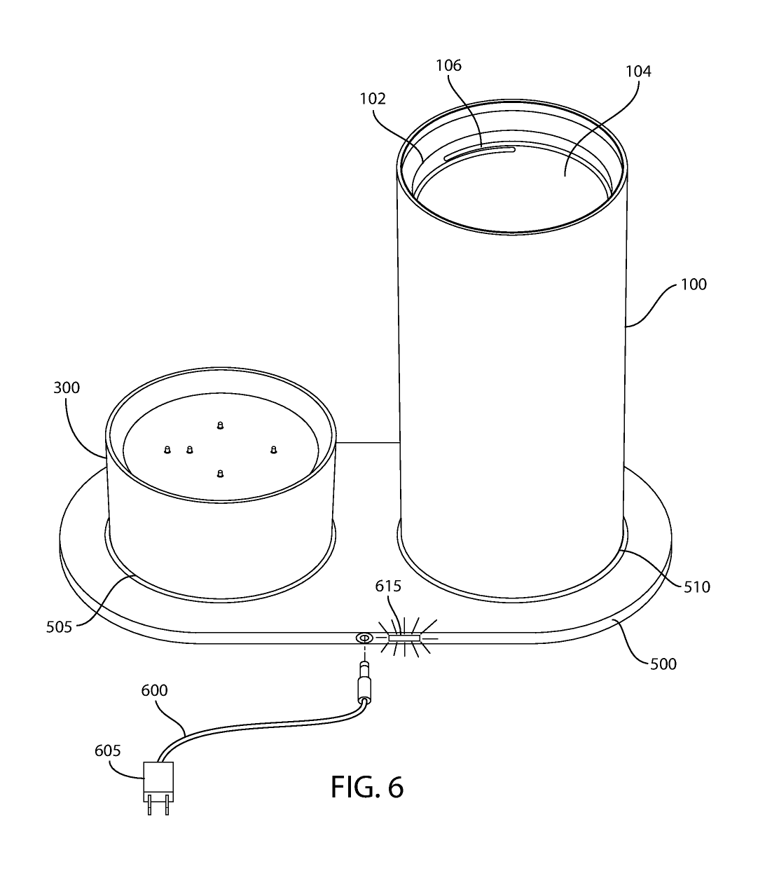

FIGS. 5 and 6 depict dual well charging dock module 500 in conjunction with cup module 100 and battery module 300. FIG. 5 illustrates a perspective view of the obverse side of charging dock module 500, which may have two substantially identical wells 505, 510. Wells 505, 510 are configured to receive cup module 100, battery module 300, or both. Wells 505, 510 also may receive for dual charging two battery modules 300. Well 505 includes four power pins 522a-d. Likewise, well 510 includes four pins 520a-d. Pins 522a-d and 520a-d are disposed to couple to cup module annular conduction rings 206, 210, or to couple to battery module annular conduction rings 410, 411 of battery module 300. In other embodiments, a single well charging dock module may be used along with pins 522a-d or 520a-d. Charging dock module 500 can be a dual well charging station, in which battery module 300 can be charged, for example, in well 510, while cup module 100 is powered in well 505 to heat a beverage therein. A port 525, such as without limitation, a USB-C port, may be disposed on the obverse side, along with optional indicator light 530, which displays the status of port 525 (e.g., charging, off).

FIG. 6 shows the reverse side of dual well charging dock module 500, holding battery module 300 shown in charging mode, in well 505, while in well 510, cup module 100 can be powered to provide heating of the cup module contents. Also shown on the reverse side of module 500 can be a power connection 600, which includes power converter 605. Power converter 605 can be used to convert AC power to DC power, and to step down voltage from 220 VAC/110 VAC to a suitable DC voltage, such as, without limitation, 20 VDC. Also, indicator light 615 may be provided to indicate power flowing into dock module 500.

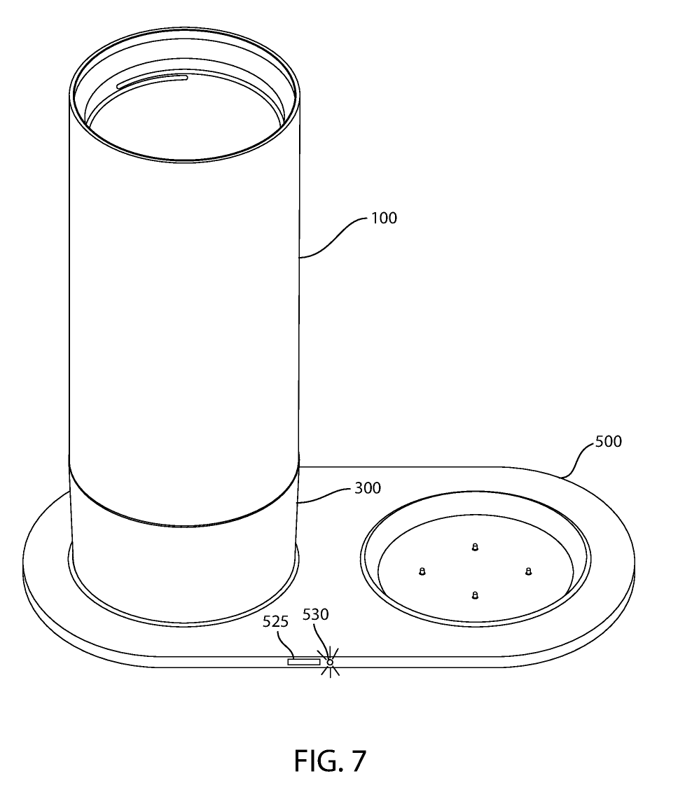

FIG. 7 illustrates stacked elements including cup module 100 stacked on battery module 300. In this configuration, battery module 300 may be charging, while passing power through to cup module 100, providing heating to the beverage in cup module 100, while on energized charging dock module 500.

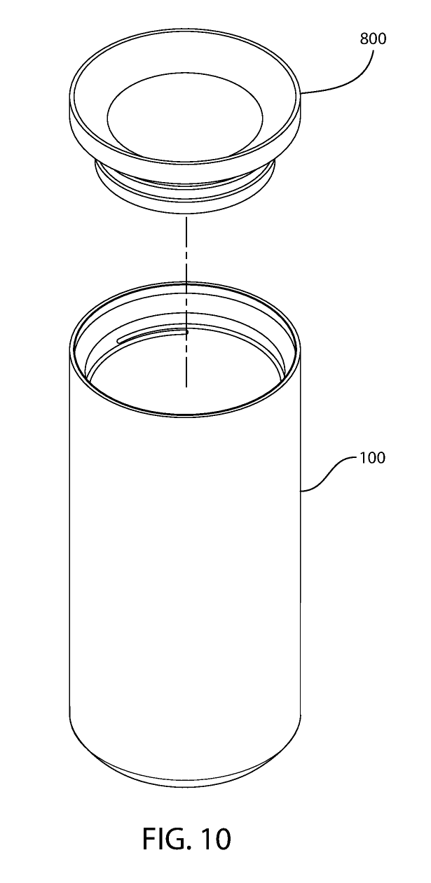

FIGS. 8, 9, and 10 illustrate cap module 800, which is threaded and configured to mate with cup module 100. Cap module 800 can rest on the opening of cup module 100 and engage cap module thread 815 with cup module thread 106. By turning cap module 800 after engagement of threads 106, 815, cap module 800 can be seated cup module 100. Cap module 800 includes lid 810, which is shown in FIG. 8 as being sealingly positioned in cap module 800 against cap rim 805. In some embodiments, O-ring seal 820 is disposed on cap module 800, such that a watertight seal is made when the O-ring is compressed between cup module 100 and cap module 800. In this position, a beverage in cup module 100 is retained within covered cup module 100. Conveniently, lid 810 can be made to enter the opened position by a single press on lid 810, as shown in FIG. 9. In FIG. 9, lid 810 is shown positioned away from cap rim 805 creating gap 900, such that the beverage can flow and be consumed by the user. A second press on lid 810 causes lid 810 to close again by moving upward to be flush with rim 805 and sealing the beverage in cup module 100.

FIG. 11 depicts a cross-section illustration of cup module 100 and battery module 300. Battery module 300 is shown to be proximate to cup module 100, in which the battery module 300 includes metal pin 315b for electrical connection. Thermal insulated cup can be constructed having cup body module 100 and a battery module 300, battery module 300 can be provided with first magnetic absorption module 1125. Cup module 100 can be provided with a second magnetic absorption module 1110. Cup module 100 can be provided with electric heating component 1100 and power interface 1115. Power interface 1115 can be connected with the electric heating component 1100, and the first magnetic absorption module 1125 and second magnetic absorption module 1110 absorb jointly to enable an electrical connection between battery module 300 and power interface 1115.

Cup module magnetic absorption module 1110 and battery module magnetic absorption module 1125 absorb jointly to enable an electrical connection between the wiring metal protrusion 315b of battery module 300 and the power interface 1115. In detaching, the magnetic absorption mating between the first magnetic absorption module 1110 and the second magnetic absorption module 1125 is separated, and the metal pin 315b of the battery module 300 is disconnected with the power interface 1115. As shown in a present embodiment in FIG. 11, the power interface 1115 comprises intermediate annular conduction ring 208 located in the second ring groove. Inner annular conduction ring 206 can be connected with the electric heating component 1100. Battery module 300 includes first electrical connector 1105 that can be electrically connected with intermediate annular conduction ring 208.

As shown in FIG. 11, in some embodiments, the first magnetic absorption module 1125 and the second magnetic absorption module 1110 are both magnets. Alternately, one of the first magnetic absorption module 1125 and second magnetic absorption module 1110 is magnet and the other thereof is a non-magnet absorption module that is able to match magnet absorption. When the first magnetic absorption module 1110 and the second magnetic absorption module 1125 are both magnets, it is necessary to adjust their polarities to enable them to match in absorption. The magnets of 1110, 1125 can be constructed such that the polarity of magnets is aligned so magnetic attraction between the magnets of 1110, 1125 draws and holds the reverse end of cup module 100 and the obverse end of battery module 300 together, when the connector ends are properly aligned.

A magnetic absorption type contact between the battery module 300 and the cup module 100 can create contact by arranging a first magnetic absorption module 1125 on the battery module and a second magnetic absorption module 1110 on the cup module 100, so that the power supply is easy to detach or change, enabling a long-time thermal holding of the thermal insulated cup. In this way, not only charging is made convenient but also connection is made convenient. FIG. 12 illustrates inverted cap module 800, depicting housing 1200 for the close/open mechanism for cap module 800.

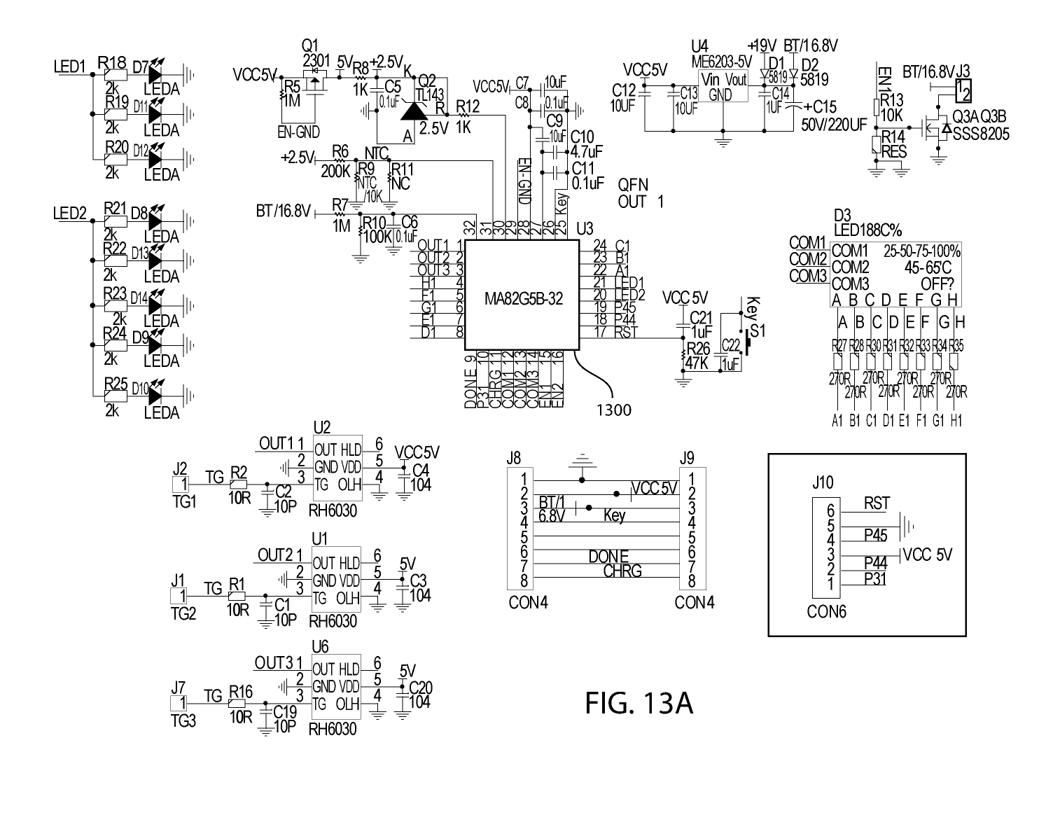

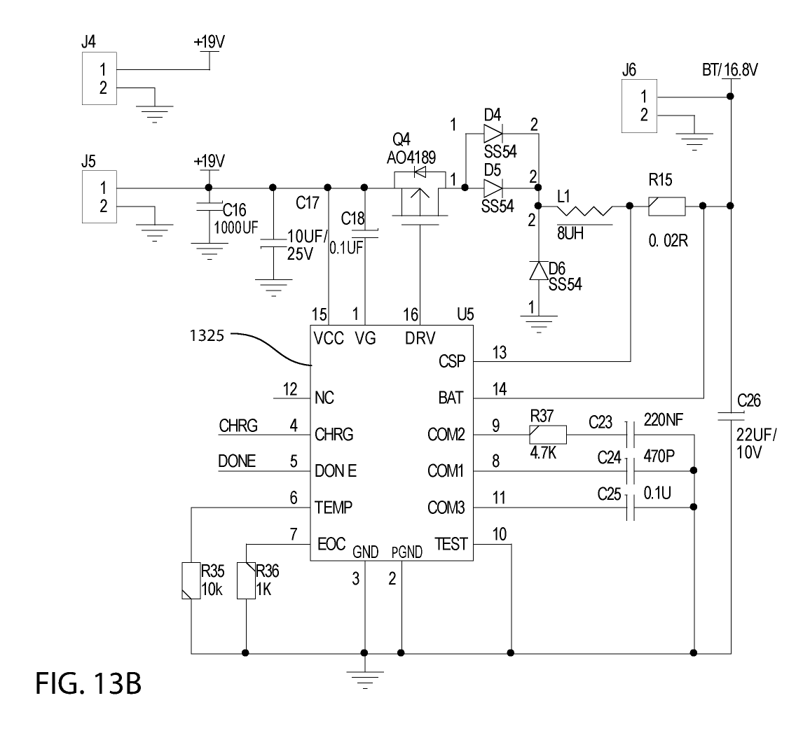

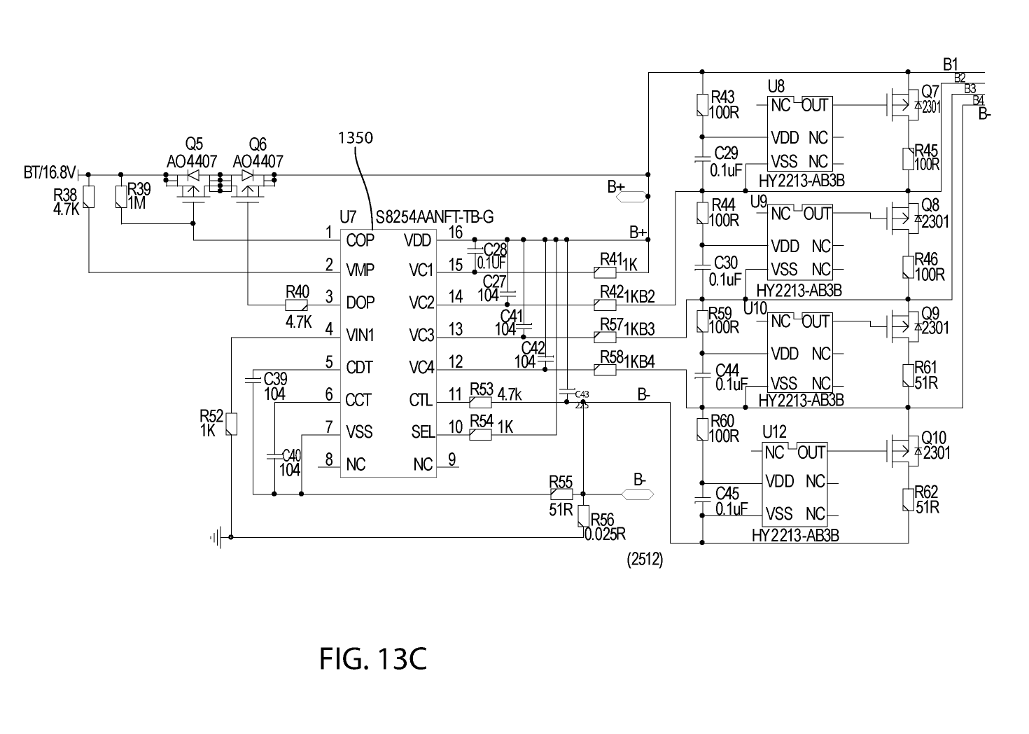

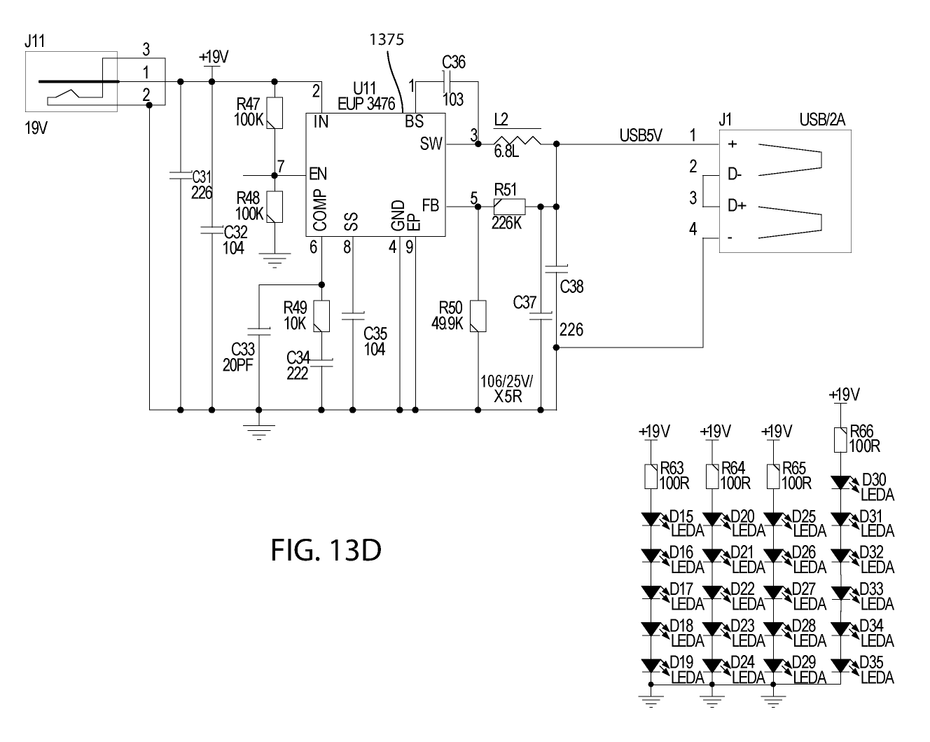

FIG. 13A-13D illustrate an electronic circuit which may be used to control the subcircuits pertaining to display, heating, battery charging, and the like. In FIG. 13A, device 1300 can be a Megawin MA82G5B-32, an 80C51-core microcontroller having 32 Kbyte Flash memory, produced by Megawin, Jhubei City, Taiwan (R.O.C.). The MA82G5B-32 microcontroller can be used for control of display, heating, and control functions. In FIG. 13B, device 1325 can be an ABLIC S-8254AANFT-BG-G Li-ion battery protection IC. The S-8254A series is a protection IC for lithium ion rechargeable batteries and includes a high-accuracy voltage detector and delay circuit. ABLIC, Chiba-shi, Japan produces the S-8254AANFT-BG-G device. In FIG. 13C, a Consonance Electronics C3702 5A, Standalone Li-ion Battery Charger with Step-down PWM charger controller 1350 is provided. Consonance Electronics is headquartered in Shanghai, China (PRC). In FIG. 13D, may be used a Eutech Microelectronics EUP3476, 3A, 28V, 500 kHz Synchronous Step-Down Converter Voltage Regulator 1375 produced by Eutech Microelectronics, Taipei City 231, Taiwan (ROC).

The embodiments of the present invention disclosed herein are intended to be illustrative only, and are not intended to limit the scope of the invention. It should be understood by those skilled in the art that various modifications and adaptations of the prevent invention as well as alternative embodiments of the prevent invention may be contemplated or foreseeable. It is to be understood that the present invention is not limited to the sole embodiments described above, but encompasses any and all embodiments within the scope of the following claims.

What is claimed is:

1. A thermal cup, comprising:
a cup module and a battery module,
wherein the battery module is provided with a first magnetic absorption element,
wherein the cup module is provided with a second magnetic absorption element,
wherein the cup module is provided with an electric heating component and a power interface,
wherein the cup module is a two-layer insulated thermal cup,
wherein the power interface is electrically coupled to the electric heating component, and
wherein the first and second magnetic absorption elements absorb jointly to enable an electrical connection between the battery module and the power interface.

2. The thermal cup of claim 1, wherein the first magnetic absorption element and the second magnetic absorption element are both magnets.

3. The thermal cup of claim 1, wherein one of the first or second magnetic absorption element is magnet and the other thereof is a non-magnet absorption element that is able to match magnet absorption.

4. The thermal cup of claim 1, wherein the cup module further comprises a base, wherein the cup module base includes a second electric connector and the battery module includes a second connector.

5. The thermal cup of claim 4, wherein the battery module includes a battery core, second metal conductor located in the second ring groove, the second metal conductor is connected with the battery core, and the base contains the second electrical connector that is electrically connected with the second metal conductor.

6. The thermal cup of claim 5, further comprising a charging dock module configured to contain the cup module or the battery module.

7. The thermal cup of claim 5, further comprising a charging dock module configured to contain the cup module and the battery module.

8. The thermal cup of claim 5, further comprising a charging dock module configured to contain two battery modules.

9. The thermal cup of claim 7, further comprising a cap module configured to sealingly fit a mouth of the cup module, and a lid in the cap module configured to open and close a lid and to selectively release contents of the cup module.

10. A thermal cup, comprising:
a cup module;
a cap module; and
a battery module,
wherein the cup module is a two-layer cup module having an inner tank,
wherein the cup module is provided with an electric heating component for warming beverages in the cup module, and a power interface,
wherein the battery module includes a rechargeable battery therein and the rechargeable battery is electrically coupled to the power interface, providing power to the electric heating component,
wherein the cap module is configured to sealingly fit onto the cup module, securing the cup module contents therein,
wherein each of the cup module and the battery have complementary magnetic elements, configured to attract each other when the cup module is magnetically proximate to the battery module, and
wherein an electrical connection is made between the cup module and the battery module when the cup module and battery module are in magnetic contact.

11. The thermal cup of claim 10, wherein the cup module further comprises:
an cup indicator element configured to indicate a condition of the cup module contents.

12. The thermal cup of claim 11, wherein the condition of the cup module contents is a temperature of the cup module contents.

13. The thermal cup of claim 11, wherein the battery module further comprises:
a battery indicator element configured to indicate a charge state of the battery module.

14. The thermal cup of claim 13, wherein the cup module further comprises an electric heating element, responsive to a temperature of cup module contents.

15. The thermal cup of claim 10, further comprising:
a docking module having a well configured to receive the cup module or the battery module.

16. The thermal cup of claim 15, further comprising:
a port disposed on an obverse side of the docking module.

17. The thermal cup of claim 16, wherein the port is a USB port.
